(19) United States
(12) Patent Application Publication
(10) Pub. No.: US 2025/0362541 A1
(43) Pub. Date: Nov. 27, 2025

(54) DISPLAY DEVICE

(71) Applicant: Japan Display Inc., Tokyo (JP)

(72) Inventor: Junko NAGASAWA, Tokyo (JP)

(21) Appl. No.: 19/173,900

(22) Filed: Apr. 9, 2025

(30) Foreign Application Priority Data
May 23, 2024 (JP) 2024-084220

(51) Int. Cl. G02F 1/1335; G02F 1/1362

(52) U.S. Cl. CPC G02F 1/133514; G02F 1/136286

(57) ABSTRACT

According to one embodiment, a display device includes a substrate, a semiconductor provided above the substrate, a pixel electrode electrically connected to the semiconductor, and a first color filter provided between the semiconductor and the pixel electrode. The first color filter includes a first layer and a second layer provided on the first layer and has the same color as that of the first layer.

### CROSS-REFERENCE TO RELATED APPLICATIONS

This application is based upon and claims the benefit of priority from Japanese Patent Application No. 2024-084220, filed May 23, 2024, the entire contents of which are incorporated herein by reference.

### FIELD

Embodiments described herein relate generally to a display device.

### BACKGROUND

As an example of display devices that can perform color display, liquid crystal display devices having a color filter on array (COA) system, in which an array substrate comprises a switching element, a pixel electrode, and a color filter, are suggested. On requests of a broader color reproduction range, color filters are made thicker and their colors are darkened in some cases.

### BRIEF DESCRIPTION OF THE DRAWINGS

FIG. 1 is a schematic exploded perspective view of a display device of an embodiment.

FIG. 2 is a schematic plan view of a display panel shown in FIG. 1.

FIG. 3 is a schematic plan view showing an example of structures of subpixels.

FIG. 4 is a view illustrating an arrangement example of color filters that a first substrate comprises.

FIG. 5 is a schematic cross-sectional view of the display panel along V-V line in FIG. 3.

FIG. 6 is a partial enlarged view showing part of a color filter and an insulating layer shown in FIG. 5.

FIG. 7 is a schematic cross-sectional view showing a color filter of a comparative example.

FIG. 8 is a schematic plan view showing another configuration example of the color filter.

### DETAILED DESCRIPTION

In general, according to one embodiment, a display device includes a substrate, a semiconductor provided above the substrate, a pixel electrode electrically connected to the semiconductor, and a first color filter provided between the semiconductor and the pixel electrode. The first color filter has a first layer and a second layer provided on the first layer and has the same color as that of the first layer.

This configuration can provide a display device capable of improving the display quality.

Embodiments will be described hereinafter with reference to the accompanying drawings. Note that the disclosure is presented for the sake of exemplification, and any modification and variation conceived within the scope and spirit of the invention by a person having ordinary skill in the art are naturally encompassed in the scope of invention of the present application. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the figures, an X axis, a Y axis, and a Z axis orthogonal to one another are described to facilitate understanding as needed. A direction along the X axis is referred to as a first direction X, a direction along the Y axis is referred to as a second direction Y, and a direction along the Z axis is referred to as a third direction Z. A plan view is defined as appearance when various types of elements are viewed parallel to the third direction Z.

In the present embodiment, as an example of display devices, a liquid crystal display device is disclosed. The technical idea disclosed in the present embodiment can be applied to, as other display devices, for example, display devices comprising other types of display elements such as an organic electroluminescent display element, a micro-LED, or a mini-LED. The technical idea disclosed in the present embodiment can be also applied to an array substrate or an electronic device that comprises a sensor element such as a capacitive sensor or an optical sensor.

The display device of the present embodiment may be used for various devices such as a vehicle-mounted device, a smartphone, a tablet, a mobile phone, a personal computer, a television receiver, a game console, and a head-mounted display.

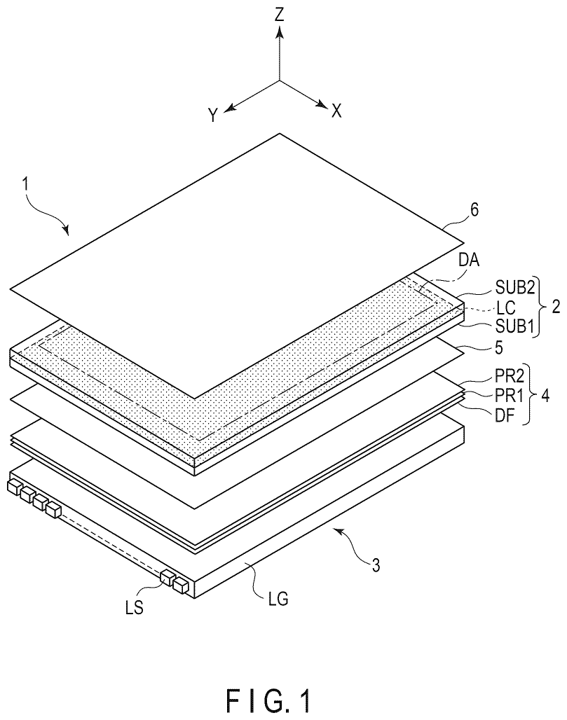

FIG. 1 is a schematic exploded perspective view of a display device 1 of the present embodiment. The display device 1 comprises a display panel 2 and an illumination device 3. The display panel 2 comprises a first substrate SUB1, a second substrate SUB2 facing the first substrate SUB1, and a liquid crystal layer LC.

In the example in FIG. 1, the illumination device 3 is a side-edge type illumination device. More specifically, the illumination device 3 comprises a light guide LG and a plurality of light emitting elements LS. The light guide LG faces the display panel 2. The plurality of light emitting elements LS face the side surfaces of the light guide LG. The illumination device 3 is not limited to the example in FIG. 1 and may have another configuration such as a direct type.

In the example in FIG. 1, the display panel 2 and the light guide LG each have a rectangular shape elongating in the second direction Y. The display panel 2 and the light guide LG may have shapes other than a rectangle.

The display device 1 further comprises an optical sheet group 4, a first polarizer 5, and a second polarizer 6. The optical sheet group 4 is provided between the light guide LG and the display panel 2. The optical sheet group 4 includes a diffusion sheet DF, a first prism sheet PR1, and a second prism sheet PR2. The diffusion sheet DF diffuses light beams emitted from the light guide LG. Many prisms are formed on the first prism sheet PR1 and the second prism sheet PR2.

The first polarizer 5 is provided between the optical sheet group 4 and the first substrate SUB1. The second polarizer 6 is provided above the second substrate SUB2. The polarization axis of the first polarizer 5 and the polarization axis of the second polarizer 6 have, for example, a crossed-Nicol relationship in which their polarization axes are orthogonal to each other.

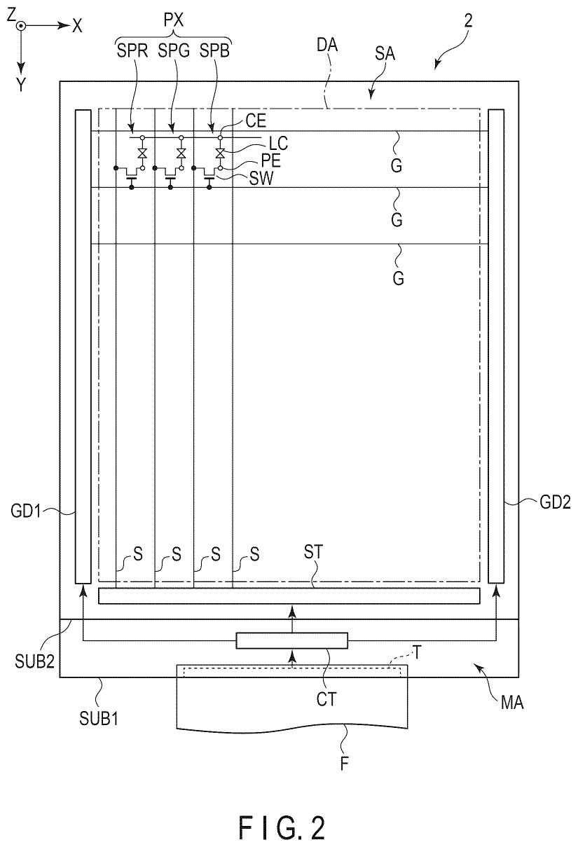

FIG. 2 is a schematic plan view of the display panel 2 shown in FIG. 1. The display panel 2 has a display area DA for displaying an image and a surrounding area SA having a frame shape and surrounding the display area DA. In the example shown in FIG. 2, the first substrate SUB1 includes a mounting area MA, which is formed on a portion extending farther than the second substrate SUB2 in the second direction Y. The mounting area MA is part of the surrounding area SA.

The display area DA includes a plurality of pixels PX arranged in a matrix in the first direction X and the second direction Y. Each pixel PX includes a plurality of subpixels. In the present embodiment, for example, each pixel PX includes a red subpixel SPR, a green subpixel SPG, and a blue subpixel SPB. The pixel PX may include a subpixel displaying another color such as white.

The display panel 2 comprises a plurality of scanning lines G, a plurality of signal lines S, scanning drivers GD1 and GD2, and a selector circuit ST. The plurality of scanning lines G extend in the first direction X and are arranged in the second direction Y. The plurality of signal lines S extend in the second direction Y and are arranged in the first direction X.

The scanning lines G are connected to at least one of the scanning drivers GD1 and GD2. Each of the signal lines S is connected to the selector circuit ST. The first substrate SUB1 includes a terminal portion T provided in the mounting area MA.

The display panel 2 further comprises a flexible printed circuit F and a controller CT. The flexible printed circuit F is connected to the terminal portion T. In the example in FIG. 2, the controller CT is mounted in the mounting area MA. The controller CT may consist of an IC chip and various types of circuit elements. The controller CT may be mounted on the flexible printed circuit F.

The controller CT controls the scanning drivers GD1 and GD2 and also controls the selector circuit ST. The scanning drivers GD1 and GD2 sequentially supply the scanning lines G with scanning signals. The selector circuit ST sequentially supplies the signal lines S with video signals.

Each of the subpixels SPR, SPG, and SPB includes a pixel electrode PE, a switching element (thin-film transistor) SW, and a common electrode CE to which a common voltage is applied. The switching elements SW is electrically connected to the pixel electrode PE, the scanning line G, and the signal line S. The common electrode CE is formed over the plurality of subpixels. When a potential difference is formed between the pixel electrode PE and the common electrode CE, an electric field based on the potential difference is formed in the liquid crystal layer LC.

In the present embodiment, all of the scanning lines G, the signal lines S, the scanning drivers GD1 and GD2, the selector circuit ST, the switching elements SW, the pixel electrodes PE, and the common electrode CE are formed on the first substrate SUB1.

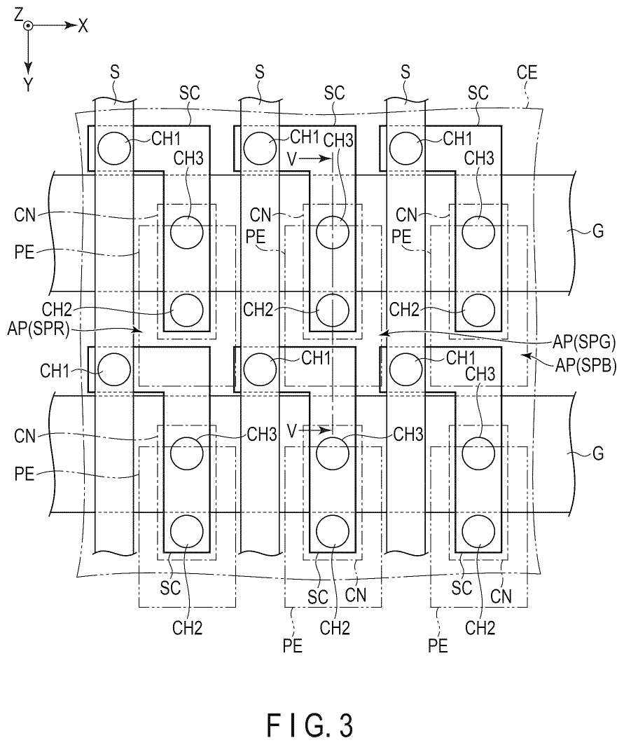

FIG. 3 is a schematic plan view showing an example of structures of the subpixels SPR, SPB, and SPG. In the example in FIG. 3, the scanning lines G linearly extend in the first direction X, and the signal lines S linearly extend in the second direction Y.

For example, the width of each scanning line G in the second direction Y is greater than the width of each signal line S in the first direction X. The scanning lines G or signal lines S are not necessarily linear and may include a curved portion.

The scanning lines G intersect the signal lines S. The area surrounded by two adjacent scanning lines G and two adjacent signal lines S corresponds to an aperture AP of each of the subpixels SPR, SPG, and SPB. Each of the subpixels SPR, SPG, and SPB has an aperture AP.

The contact hole CH1 overlaps the signal line S. The contact hole CH2 (the first contact hole) overlaps the aperture AP. The contact hole CH3 (the second contact hole) overlaps the scanning line G.

Each of the subpixels SPR, SPG, and SPB further includes a connection electrode CN and a semiconductor SC. The following focuses on the subpixel SPG and mainly describes the connection electrode CN, the semiconductor SC, and the pixel electrode PE. The subpixels SPR and SPB have the same configuration as the subpixel SPG.

For example, the connection electrode CN has a shape elongating in the second direction Y. The connection electrode CN is provided between the signal lines S that are adjacent to each other in the first direction X. The connection electrode CN overlaps the scanning line G and extends toward the aperture AP in the second direction Y. As shown in FIG. 3, the connection electrode CN overlaps part of the aperture AP

For example, the semiconductor SC is substantially L-shaped. The semiconductor SC intersects the signal line S in the first direction X. The semiconductor SC intersects the scanning line G and extends toward the aperture AP in the second direction Y.

The semiconductors SC are electrically connected to the signal lines S in the contact holes CH1. The semiconductors SC are electrically connected to the connection electrodes CN in the contact holes CH2.

For example, the pixel electrode PE has a shape elongating in the second direction Y. The pixel electrode PE is provided between the signal lines S that are adjacent to each other in the first direction X. The pixel electrode PE overlaps the scanning line G and extends toward the aperture AP in the second direction Y. As shown in FIG. 3, the pixel electrode PE overlaps the aperture AP. The pixel electrode PE is electrically connected to the connection electrode CN in the contact hole CH3.

The common electrode CE is provided over the plurality of subpixels SPR, SPG, and SPB. The common electrode CE has slits (not shown) in the subpixels SPR, SPG, and SPB. A common voltage is applied to the common electrode CE.

Scanning signals supplied to the scanning lines G turns on the switching element SW, and then video signals to be supplied to the signal lines S are applied to the pixel electrode PE via the connection electrode CN. At this time, an electric field is formed between the pixel electrode PE and the common electrode CE in the vicinity of the slits.

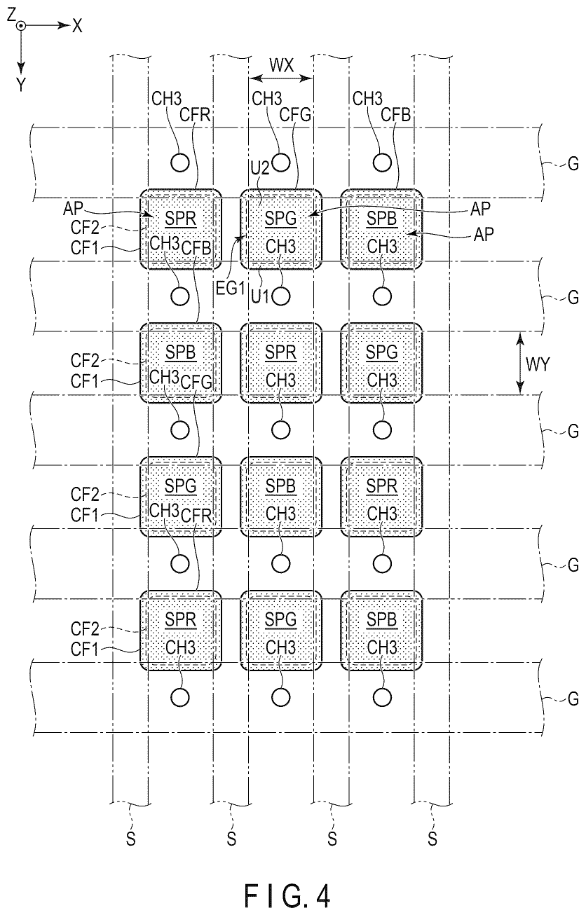

FIG. 4 is a view illustrating an arrangement example of color filters CFR, CFG, and CFB that the first substrate SUB1 comprises. In the example in FIG. 4, the subpixels SPR, SPG, and SPB are arranged in this order in the first direction X, and the subpixels SPR, SPB, and SPG are arranged in this order in the second direction Y. The arrangement example of the subpixels SPR, SPG, and SPB is not limited to the illustrated examples.

The first substrate SUB1 further comprises the color filters CFR, CFG, and CFB. The color filter CFG corresponds to an example of the first color filter. The color filter CFR corresponds to an example of the second color filter. The color filter CFB corresponds to an example of the third color filter.

These color filters CFR, CFG, and CFB have different colors. For example, the color filter CFG is green, the color filter CFR is red, and the color filter CFB is blue.

When illumination light emitted from the illumination device 3 (shown in FIG. 1) passes through the color filter CFR, red display light is generated. When illumination light passes through the color filter CFG, green display light is generated. When illumination light passes through the color filter CFB, blue display light is generated.

In each subpixel SPR, the color filter CFR overlaps the aperture AP. In each subpixel SPG, the color filter CFG overlaps the aperture AP. In each subpixel SPB, the color filter CFB overlaps the aperture AP.

For example, each of the color filters CFR, CFG, and CFB is provided in an island-like shape per the aperture AP. These color filters CFR, CFG, and CFB are spaced apart from one another in the areas overlapping the scanning lines G and the areas overlapping the signal lines S. The contact hole CH3 does not overlap each of the color filters CFR, CFG, and CFB.

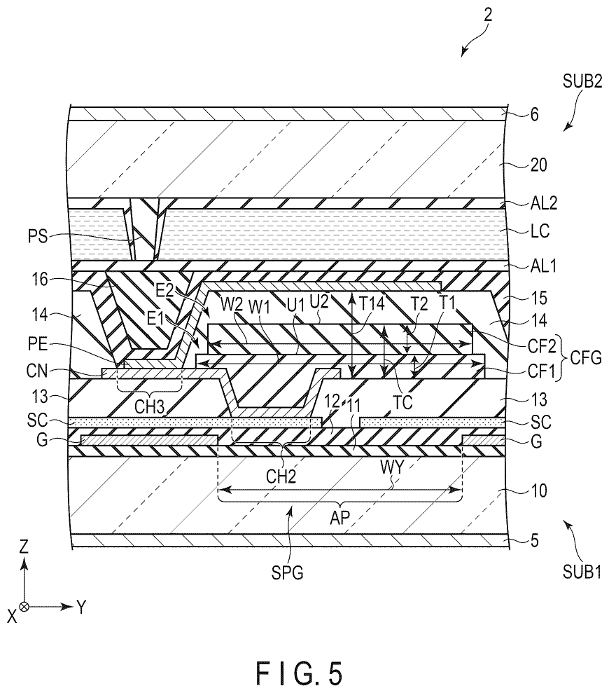

FIG. 5 is a schematic cross-sectional view of the display panel 2 along V-V line in FIG. 3. FIG. 5 mainly shows the cross-section including the subpixel SPG. FIG. 5 shows an example of the configuration of the display panel 2. The configuration is not limited to this example.

As described above, the first substrate SUB1 comprises the plurality of scanning lines G, the plurality of signal lines S (shown in FIG. 3), the semiconductor SC, the pixel electrode PE, the connection electrode CN, and the color filter CFG. The first substrate SUB1 comprises a substrate 10, insulating layers 11 to 15, a filler layer 16, and an alignment film AL1.

The substrate 10 is, for example, a transparent insulating substrate such as a glass substrate or a resinous substrate. The insulating layer 11 is provided on the substrate 10. The scanning lines G are provided on the first insulating layer 11. The aperture AP is formed between adjacent scanning lines G.

The insulating layer 12 is provided on the plurality of scanning lines G and the insulating layer 11. The semiconductor layer SC of the switching element SW is provided on the insulating layer 12. That is, the semiconductor SC is provided above the substrate 10.

An insulating layer 13 (an inorganic insulating layer) is provided on the semiconductor SC and the insulating layer 12. The insulating layer 13 includes the contact hole CH2. The contact hole CH2 penetrates the insulating layer 13. The contact hole CH2 overlaps the semiconductor SC.

The connection electrode CN is provided on the insulating layer 13. The connection electrode CN is provided on a layer different from that of the scanning lines G. The connection electrode CN is provided between the insulating layer 13 and the color filter CFG. The connection electrode CN contacts the semiconductor SC via the contact hole CH2.

The color filter CFG is provided on the connection electrode CN and the insulating layer 13. From another viewpoint, the insulating layer 13 is provided between the semiconductor SC and the color filter CFG. The color filter CFG overlaps the aperture AP. The contact hole CH2 overlaps the color filter CFG.

The color filter CFG has a first layer CF1 and a second layer CF2. The first layer CF1 is provided on the connection electrode CN and the insulating layer 13. The contact hole CH2 is filled with part of the first layer CF1 fills. That is, the first layer CF1 contacts the connection electrode CN in the contact hole CH2.

The first layer CF1 is green. The first layer CF1 has an upper surface U1. As shown in FIG. 4, the upper surface U1 is greater than the aperture AP in plan view. That is, as shown in FIG. 4, a peripheral portion E1 of the first layer CF1 overlaps two of the scanning lines and two of the signal lines.

The second layer CF2 is the same color (green) as the first layer CF1. The second layer CF2 is provided on the upper surface U1 of the first layer CF1. For example, the second layer CF2 overlaps the contact hole CH2.

The second layer CF2 has an upper surface U2. In the example in FIG. 5, a width W2 in the second direction Y of the second layer CF2 is smaller than a width W1 in the second direction Y of the first layer CF1 (W1>W2). Further, as shown in FIG. 4, the width in the first direction X of the second layer CF2 is smaller than the width in the first direction X of the first layer CF1.

Further, in the example in FIG. 5, the width W1 is greater than a width WY in the second direction Y of the aperture AP. The width WY in the second direction Y of the aperture AP is equivalent to an interval between adjacent scanning lines G. Further, the width in the first direction X of the first layer CF1 is greater than a width WX (shown in FIG. 4) in the first direction X of the aperture AP. The width WX in the first direction X of the aperture AP is equivalent to an interval between adjacent signal lines S.

Further, the upper surface U2 may be greater than the aperture AP in plan view. More specifically, in the example in FIG. 5, the width W2 may be greater than the width WY in the second direction Y of the aperture AP. Further, the width in the first direction X of the second layer CF2 may be greater than the width WX in the first direction X of the aperture AP.

In the color filter CFG, the first layer CF1 is greater than the aperture AP, and the second layer CF2 may be smaller than the aperture AP.

With respect to thicknesses, a thickness T1 of the first layer CF1 is, for example, smaller than a thickness T2 of the second layer CF2 (T1<T2). In this example, thicknesses refer to lengths (distances) along the third direction Z. The thickness T1 is equivalent to the distance between the upper surface of the insulating layer 13 to the upper surface U1 of the first layer CF1.

The insulating layer 14 (an organic insulating layer) is provided on the color filter CFG and the connection electrode CN. That is, the insulating layer 14 covers the first layer CF1 and the second layer CF2.

Here, the thickness of the color filter CFG is referred to as a thickness TC, and the sum of the thickness TC of the color filter CFG and the thickness of the insulating layer 14 is referred to as a thickness T14. The thickness TC is equivalent to the sum of the thickness T1 of the first layer CF1 and the thickness of the color filter CF2. The thickness T14 is equivalent to the distance between the upper surface of the insulating layer 13 and the upper surface of the insulating layer 14.

The thickness T1 of the first layer CF1 is, for example, 2 μm or less. The thickness TC of the color filter CFG is, for example, 2 μm to 5 μm. The thickness T14, which is the sum of the thicknesses of the color filter CFG and the insulating layer 14, is, for example, 5 μm or more.

The contact hole CH3 is formed in the insulating layer 14. That is, the contact hole CH3 penetrates the insulating layer 14. The contact hole CH3 overlaps not the color filter CFG but the scanning lines G. The width of the contact hole CH3 is, for example, about 2 μm.

With respect to the contact holes CH2 and CH3, in the example in FIG. 5, the peripheral portion E1 of the first layer CF1 and a peripheral portion E2 of the second layer CF2 are located between the contact hole CH2 and the contact hole CH3 in the second direction Y.

In the color filter CFG, the peripheral portion E1 of the first layer CF1 is located between the contact hole CH2 and the contact hole CH3. The peripheral portion E2 of the second layer CF2 may not be located between the contact hole CH2 and the contact hole CH3.

The pixel electrode PE is provided on the insulating layer 14. The pixel electrode PE contacts the connection electrode CN through the contact hole CH3. That is, the pixel electrode PE is electrically connected to the semiconductor SC via the connection electrode CN. The insulating layer 15 is provided on the insulating layer 14 and the pixel electrode PE. The insulating layer 15 has a function of planarizing irregularities formed by the color filter CFG and the like.

In the example in FIG. 5, the filer layer 16 fills a recess portion formed by the contact hole CH3. For example, the filer layer 16 is formed of an organic insulating material. The alignment film AL1 is provided on the insulating layer 15 and the filer layer 16.

The common electrode CE (shown in FIG. 3) is provided on the insulating layer 15. In each of the subpixels SPR, SPG, and SPB, the pixel electrode PE faces the common electrode CE via the insulating layer 15.

The insulating layers 11 to 13 and 15 are inorganic insulating layers. The insulating layer 14 is an organic insulating layer. For example, each of the insulating layers 11 to 13 and 15 is formed of an inorganic insulating material such as a silicon nitride or a silicon oxide. The insulating layer 14 is formed of an organic insulating material such as an acrylic resin. The insulating layer 14 is a positive photosensitive resin.

The alignment film AL1 is formed of, for example, a polyimide, and is a horizontal alignment film having an alignment restriction force parallel to the X-Y plane. The color filter CFG is formed of, for example, a negative photosensitive resin.

The signal lines S (shown in FIG. 2) and the scanning lines G are formed of a metal material such as titanium, aluminum, molybdenum, or tungsten. The signal lines S and the scanning lines G may be formed of a single-layer body or may be formed of a stacked layer body in which different types of metal layers are stacked.

The pixel electrodes PE, the connection electrodes CN, and the common electrode CE (shown in FIG. 3) are formed of a transparent conductive material such as indium tin oxide (ITO). The semiconductor SC is transparent, and is, for example, an oxide semiconductor containing indium, gallium, and the like.

The second substrate SUB2 faces the first substrate SUB1 in the third direction Z. The second substrate SUB2 comprises an substrate 20 and an alignment film AL2. The substrate 20 is, for example, a transparent insulating substrate such as a glass substrate or a resinous substrate.

The alignment film AL2 is formed of, for example, a polyimide, and is a horizontal alignment film having an alignment restriction force parallel to the X-Y plane. The second substrate SUB2 may further comprise a light-shielding layer such as what is called a black matrix.

The liquid crystal layer LC is provided between the first substrate SUB1 and the second substrate SUB2. The display panel 2 may further comprise a spacer PS. The spacer PS is provided between the first substrate SUB1 and the second substrate SUB2.

The spacer PS is provided to adjust the distance between the first substrate SUB1 and the second substrate SUB2. The spacer PS is provided above the scanning lines G and the contact hole CH3, for example, in the third direction Z. The width of the spacer PS, is for example, about 1 μm.

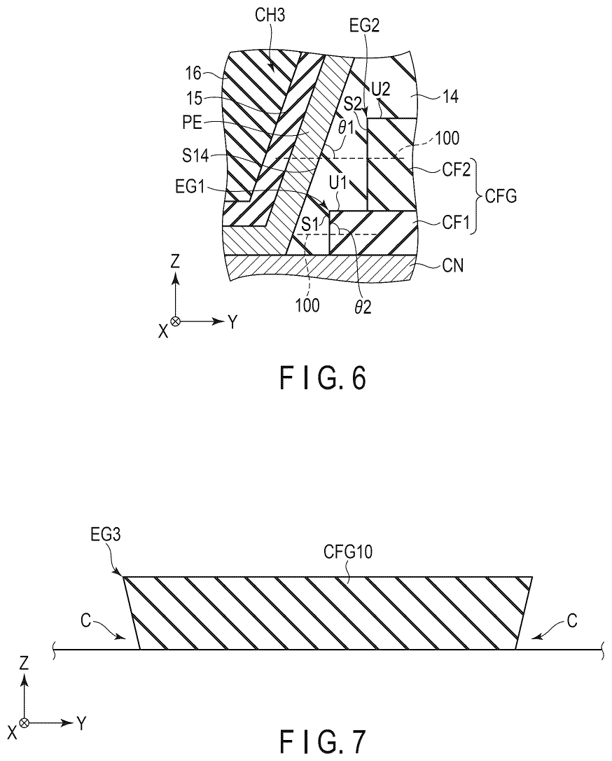

The following describes the relationship between the color filter CFG and the insulating layer 14. FIG. 6 is a partial enlarged view showing part of the color filter CFG and part of the insulating layer 14 shown in FIG. 5. FIG. 6 shows the vicinity of the contact hole CH3.

The first layer CF1 has a side surface S1. The side surface S1 is substantially parallel to an X-Z plane defined by the first direction X and the third direction Z. Here, “substantially parallel” includes cases where surfaces are slightly tilted with respect to the X-Z plane.

The second layer CF2 has a side surface S2. The side surface S2 is substantially parallel to the X-Z plane. The side surface S1 is closer to the contact hole CH3 in the second direction Y than the side surface S2 is. The side surfaces S1 and S2 are respectively included in the peripheral portions E1 and E2.

A corner portion EG1 formed by the upper surface U1 and the side surface S1 of the first layer CF1 is about 90 degrees, as shown in FIG. 6. A corner portion EG2 formed by the upper surface U2 and the side surface S2 of the second layer CF2 is about 90 degrees, as shown in FIG. 6.

The side surfaces S1 and S2 and the corner portions EG1 and EG2 are covered with the insulating layer 14. The corner portions EG1 and EG2 are not exposed to the contact hole CH3. That is, the corner portions EG1 and EG2 do not contact the pixel electrode PE.

The insulating layer 14 has a surface S14. In the present embodiment, the surface S14 is the inner surface of the contact hole CH3. The surface S14 defines the contact hole CH3. The surface S14 is a tilted plane. In FIG. 6, the tilt of the surface S14 is constant. The tilt is not limited to this example.

A plane (a reference plane) parallel to the main surface of the substrate 10 is referred to as a surface 100. For example, the surface 100 is parallel to the X-Y plane. FIG. 6 shows the surface 100 with broken lines. The angle between the surface 100 and the surface S14 is referred to as an angle θ1. The angle between the surface 100 and the side surface S1 is referred to as an angle θ2.

For example, the angle θ1 is the angle in the center portion in the third direction Z of the surface S14. The angle θ2 is the angle in the center portion in the third direction Z of the surface S1. These angles are not limited to these examples. As shown in FIG. 6, the angles θ1 and θ2 are counterclockwise from the reference plane in the first direction X. In the example shown in FIG. 6, the angle θ1 is smaller than the angle θ2 (θ1<θ2). More specifically, the angle θ1 is 72 degrees or less, and the angle θ2 is 90 degrees or less. For example, the angle Θ1 is about 72 degrees, and the angle θ2 is about 90 degrees.

The above describes the color filter CFG. As shown in FIG. 5, the red color filter CFR of the subpixel SPR and the blue color filter CFB of the subpixel SPB are constituted by two layers (the first layer CF1 and the second layer CF2) in the same manner as the color filter CFG.

FIG. 7 is a schematic cross-sectional view showing a color filter CFG10 of a comparative example. For example, the color filter CFG10 is formed by applying a filter material, exposing the filter material by applying light (for example, ultraviolet rays) onto it through a mask having an aperture of a specific shape, and then developing and annealing it.

As described above, the color filter CFG10 is formed of a negative photosensitive resin. Thus, areas exposed to light remain and areas shielded from light by the mask are removed. If the color filter CFG10 is thicken, light exposure amount may be insufficient in a position remote from a light source (the bottom portion of the color filter CFG10) in the above light exposure step.

In particular, the green color filter CFG10 has a lower transmittance of ultraviolet rays that are used in light exposure than other color filters. Thus, it is difficult for ultraviolet rays to reach the bottom portion of the color filter CFG10.

When development is conducted with such insufficient light exposure, undercut C may occur in the bottom portion of the color filter CFG10, as shown in FIG. 7. That is, the width of upper portion of the color filter CFG10 becomes greater than the width of the bottom portion.

When such an undercut C occurs, the insulating 14 cannot easily cover areas involving the undercut C. That is, part of the color filter layer CFG10 has the risk of being easily exposed from the insulating layer 14.

For example, the pixel electrode PE provided on the insulating layer 14 has the risk of being broken by a corner portion EG3 of the color filter CFG10. Thus, the display device 1 has the risk of illumination failure.

In the present embodiment, the color filter CFG has the first layer CF1 and the second layer CF2 provided on the first layer CF1. Forming the color filter CFG by two layers enable suppressing the occurrence of the undercut C due to insufficient light exposure and enable thickening the color filter CFG.

More specifically, the first layer CF1 has the thickness enabling light beams to reach the bottom portion, in the manufacturing process. Thus, the undercut C does not easily occur in the first layer CF1 in the manufacturing process.

Specifically, forming the green color filter layer CFG by two layers can suppress the occurrence of the undercut C. Further, forming the second layer CF2 of the same color as the first layer CF1 can further thicken the color filter CFG.

This increases the color reproduction performance of the display device 1. That is, generating desired display light beams enlarges a color-discernible area. As a result, the display device 1 capable of improving the display quality can be provided.

Further, suppressing the occurrence of the undercut C enables the insulating layer 14 to easily cover up to the bottom surface of the color filter CFG. This can suppress the side surfaces S1 and S2 and the corner portions EG1 and EG2 of the color filter CFG being exposed from the insulating layer 14. As a result, this suppresses a break of the pixel electrode PE due to the color filter CFG and also suppresses the occurrence of illumination failure.

Further, the insulating layer 14 assuredly covering the color filter layer CFG can suppress outflow of impurities from the color filter CFG into the contact hole CH3 and the contamination of the manufacturing device (for example, a film forming chamber) by the impurities.

Further, even when the content of colorant in the color filter increases or the color filter becomes thicker on the request of broadening color reproduction range, the color filters CFG constituted by a plurality of layers can be adjusted to have a desired thickness or a desired content of the colorant.

Further, in the present embodiment, the first layer CF1 entirely overlaps the aperture AP. That is, all parts of the aperture AP overlap the color filter CFG. Thus, all of light beams passing through the aperture AP pass through the color filter CFG. As a result, the display quality of the display device 1 can be improved.

The COA system comprising the color filters CFR, CFG, and CFB, as that in the present embodiment, is particularly suitable for the display device 1 expected to have high definition. The application of the display device 1 includes, for example, Virtual Reality (VR).

The display device DSP 1 configured as described above can improve the display quality. Various other desirable effects can be obtained from the present embodiment.

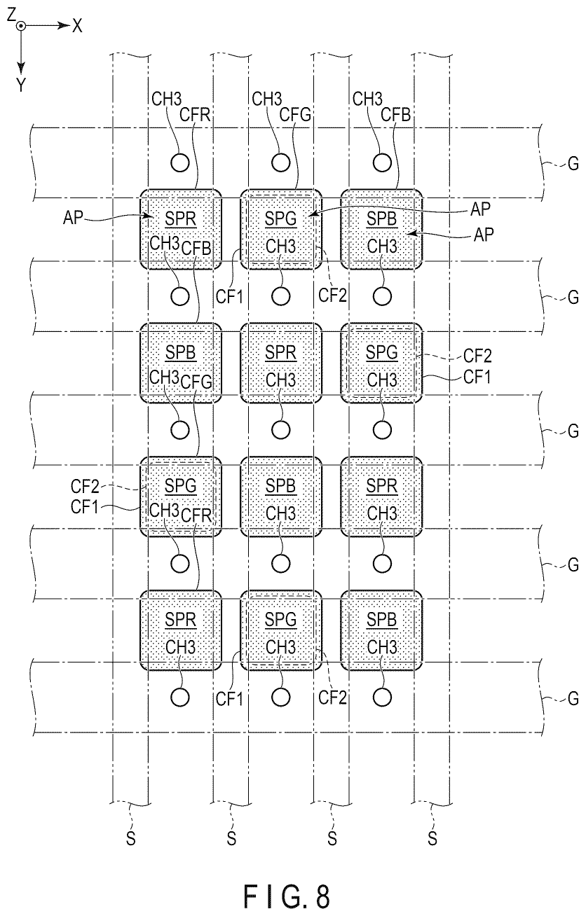

The present embodiment describes the examples where the color filters CFR, CFG, and CFB each are constituted by two layers. The configurations of the color filters are not limited to this example. FIG. 8 is a schematic plan view showing another configuration example of the color filters CFR, CFG, and CFB. In the example in FIG. 8, the color filters CFR and CFB each are constituted by a single layer.

Further, as another example, the color filters CFR and CFG each may be constituted by two layers, and the color filter CFB may be constituted by a single layer. Further, as another example, the color filters CFG and CFB each may be constituted by two layers, and the color filter CFR may be constituted by a single layer.

All of the display devices that can be implemented by a person of ordinary skill in the art through arbitrary design changes to the display device described above as the embodiment of the present invention come within the scope of the present invention as long as they are in keeping with the spirit of the present invention. Various modified examples that may be conceived by a person of ordinary skill in the art in the scope of the idea of the present invention will also fall within the scope of the invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device, comprising:
a substrate,
a semiconductor provided above the substrate,
a pixel electrode electrically connected to the semiconductor, and
a first color filter provided between the semiconductor and the pixel electrode, wherein
the first color filter has a first layer and a second layer provided on the first layer and having the same color as that of the first layer.

2. The display device of claim 1, wherein
the first color filter is green.

3. The display device of claim 1, further comprises:
an organic insulating layer covering the first layer and the second layer,
wherein
the organic insulating layer is formed of a positive photosensitive resin, and
the first color filter is formed of a negative photosensitive resin.

4. The display device of claim 1, further comprising:
two scanning lines adjacent to each other and provided above the substrate; and
two signal lines intersecting the two scanning lines, wherein
the first color filter overlaps an aperture surrounded by the two scanning lines and the two signal lines, and
a width of the first layer is greater than a width of the aperture.

5. The display device of claim 4, wherein
a width of the second layer is smaller than the width of the first layer.

6. The display device of claim 5, wherein
the width of the second layer is greater than the width of the aperture.

7. The display device of claim 1, further comprising:
two scanning lines adjacent to each other and provided above the substrate; and
two signal lines intersecting the two scanning lines, wherein
a peripheral portion of the first layer overlaps the two scanning lines and the two signal lines.

8. The display device of claim 4, further comprises:
an inorganic insulating layer provided between the semiconductor and the first color filter; and
a connection electrode provided on the inorganic insulating layer, wherein
the organic insulating layer has a first contact hole overlapping the aperture,
the connection electrode is electrically connected to the semiconductor in the first contact hole, and
part of the first layer fills the first contact hole.

9. The display device of claim 8, wherein
the second layer overlaps the first contact hole.

10. The display device of claim 8, further comprising:
an organic insulating layer covering the first layer and the second layer, wherein
the organic insulating layer has a second contact hole overlapping the scanning line,
the pixel electrode is electrically connected to the connection electrode in the second contact hole, and
an angle between an inner surface of the second contact hole and a surface parallel to a main surface of the substrate is smaller than an angle between a side surface of the first layer and the surface parallel to the main surface of the substrate.

11. The display device of claim 10, wherein
the angle between the inner surface of the second contact hole and the surface parallel to the main surface of the substrate is 72 degrees or less.

12. The display device of claim 10, wherein
the organic insulating layer covers a side surface of the first layer.

13. The display device of claim 1, wherein
a thickness of the first layer is smaller than a thickness of the second layer.

14. The display device of claim 1, wherein
a thickness of the first layer is 2 μm or less.

15. The display device of claim 14, further comprising:
an organic insulating layer covering the first layer and the second layer, wherein
a sum of the thickness of the first layer, a thickness of the second layer, and a thickness of the organic insulating layer is 5 μm or more.

16. The display device of claim 2, further comprising:
a second color filter having a color different from that of the first color filter; and
a third color filter having a color different from those of the first color filter and the second color filter, wherein
at least one of the second color filter and the third color filter is formed of two layers.

17. The display device of claim 2, further comprising:
a second color filter having a color different from that of the first color filter,
a third color filter having a color different from those of the first color filter and the second color filter, wherein
each of the second color filter and the third color filter is formed of a single layer.

18. The display device of claim 1, further comprises:
a first substrate comprising the substrate, the semiconductor, the first color filter, and the pixel electrode;
a second substrate facing the first substrate; and
a liquid crystal layer located between the first substrate and the second substrate.
